(19) United States
(12) Patent Application Publication
(10) Pub. No.: US 2013/0136540 A1
(43) Pub. Date: May 30, 2013

(54) WELDING METHOD OF A FIRST TO A SECOND TUBULAR, THE TUBULARS COMPRISING A CORROSION RESISTANT ALLOY ON AN INTERNAL FACE THEREOF

(71) Applicants: Richard Jones, Oakington (GB); Tony Clough, Kuala Lumpur (MY)

(72) Inventors: Richard Jones, Oakington (GB); Tony Clough, Kuala Lumpur (MY)

(73) Assignee: SUBSEA 7 LIMITED, Aberdeen, Aberdeenshire (GB)

(21) Appl. No.: 13/695,017

(22) PCT Filed: Apr. 26, 2011
(86) PCT No.: PCT/GB2011/050820

§ 371 Date: Feb. 13, 2013

(30) Foreign Application Priority Data
Apr. 26, 2010 (GB) 1006920.1

(51) Int. Cl. F16L 13/02; B23K 13/01; F16L 1/12; B23K 31/02

(52) U.S. Cl. CPC F16L 13/02; B23K 31/02; B23K 13/015; F16L 1/12
USPC 405/170; 228/226; 219/61

(57) ABSTRACT

A method of butt welding a first and second tubular to join them together, the tubulars being suitable for use in an underwater environment and normally being made from carbon steel and having a corrosion resistant alloy (CRA) provided on an internal face thereof, the method comprising: depositing from an external side of the first and second tubulars, a weld-filler material onto a butt joint between the first and second tubulars. Preferably the weld filler on the external side is a carbon steel weld filler and for the internal side is a CRA weld filler. In this manner sufficiently strong circumferential welds may be provided especially for CRA clad tubulars. A method of deploying the tubulars underwater and an apparatus comprising tubulars welded together is also disclosed.

This invention relates to a welding method for tubulars suitable for use underwater for the transportation of corrosive, well stream fluids such as oil, gas and water.

Typically such tubulars may comprise a solid carbon steel or corrosion resistant alloy (CRA) pipe. Alternatively they may comprise a carbon steel substrate pipe with a corrosion resistant alloy (CRA) provided in the tubular's inner diameter, commonly referred to as clad or lined pipe. The CRA forming the pipe may be mechanically or metallurgically bonded to the steel substrate and is referred to as a lined or clad pipe respectively depending on its bond with the steel substrate. The CRA lining/cladding may be used to transport aggressive/corrosive well stream fluids for which bare carbon steel pipe affords little corrosion protection.

The manufacture and installation of a string of such tubulars offshore is a time-consuming process, often performed in difficult conditions. To facilitate their deployment it is preferred to manufacture such pipe strings onshore and to store and deploy the string of tubulars from a reel at the point of installation offshore.

The manufacture of reelable clad steel caternary risers (SCRs) for subsea transportation of well stream fluids requires close control of the manufacturing process. This ensures that the circumferential butt welds between risers can achieve the necessary high quality standards needed for the demanding service environment.

In particular:
The inner diameter portion of the butt weld should have overmatching corrosion resistance relative to the CRA material.
The circumferential butt welds should be substantially free of internal defects whilst no surface or near surface breaking defects are allowable.
The resultant circumferential butt welds should also have good external and internal weld profiles with smooth transitions to the adjacent pipe material.
The weld filler materials and weld procedures should be capable of depositing weld metal with the necessary fracture toughness, weld metal strength and corrosion resistance to ensure weld integrity during both pipeline installation and subsequent service.
The pipeline circumferential butt welds should achieve the required fatigue life for the anticipated SCR loading conditions.

Similar requirements can be defined for circumferential butt welds in reelable clad flowlines with the exception of specified requirements for fatigue life.

Up to the present time, conventional welding of clad pipe involves making a weld joint using a CRA filler material. The weld composition provided by a CRA filler is tolerant to dilution by the carbon steel substrate material without undue risk of weld cracking. Also the filler wire type is selected to provide near matching coefficient of thermal expansion relative to the steel substrate material. The most commonly used weld-filler is of Ni-base composition, such as Alloy 625. Such circumferential welds are made entirely from the external side using the Alloy 625 filler wire throughout. Suitable welding processes include Shielded Metal Arc Welding (SMAW), Gas Tungsten Arc Welding (GTAW) and Gas Metal Arc Welding (GMAW).

However the inventor of the present invention has noted that the use of high strength substrate pipe material, i.e. possibly Grade X65 and higher grades such as X70, X80, or even X100, the achievable weld strength with the conventional weld procedure using Alloy 625 weld filler wire no longer satisfies the requirements for reeled pipelines in the as-welded condition. For such applications, the weld strength is required to overmatch that of the parent substrate material by a factor of not less than 120 MPa above the Specified Minimum Yield Strength (SMYS), which in the case of Grade X65 linepipe is a minimum of 445 Mpa, for Grade X80 linepipe is a minimum of 555 Mpa, and for Grade x100 is a minimum of 690 Mpa. (This strength level is only accomplished in the weld metal following work hardening due to cold deformation processes)

Thus at the present time, conventional welding solutions using an Alloy 625 filler wire can only be applied to reeled clad steel tubulars with strengths up to that of Grade X60, and possibly X65 but definitively not suitable for higher grades such as X70 or higher.

According to a first aspect of the present invention there is provided a method of butt welding a first and second tubular to join them together, the tubulars being suitable for use in an underwater environment and comprising a corrosion resistant alloy on an internal face thereof, the method comprising:
depositing from an external side of the first and second tubulars, a weld-filler material onto a butt joint between the first and second tubulars, then
depositing from an internal side of the first and second tubulars, a weld-filler material onto a butt joint between the first and second tubulars.

Preferably therefore the invention also provides a method for deploying tubulars in an underwater environment, the method comprising welding the tubulars together according to the first aspect of the invention and deploying the welded tubulars in said underwater environment.

The underwater environment is typically subsea.

The corrosion resistant alloy may be mechanically bonded to the tubulars to form a lining or chemically/metallurgically bonded to the tubulars to form a cladding.

Normally the thickness of the corrosion resistant material is less than the thickness of the tubulars without the corrosion resistant material.

The tubulars may be pipelines, such as flowlines and steel clad caternary risers.

A benefit of certain embodiments is the close control of the weld and especially the quality of the surface of the weld at the internal side of the tubulars. Moreover, should the integrity of the weld be in doubt at the internal side of the weld, then it may be reworked at this internal side, rather than reworking the weld from the external side, which would, in such an instance, require the entire weld to be removed.

Preferably the outer diameter of the tubular is less than 24″ (61 cm), more preferably less than 20″ (51 cm) and particularly preferred embodiments are not greater than 16″ (40.5 cm). Normally the outer diameter of the tube is more than 4″ (10 cm) and preferably more than 8″ (20 cm).

For preferred embodiments, the tubulars are formed from a carbon steel tube having the corrosion resistant alloy provided on the internal face of the tube. The carbon steel tube may be rated to above X65, for example X70, X80 or X100.

Preferably the welding on the internal face is performed using a non-consumable electrode welding technique. A non-consumable electrode welding technique is one where an electrode and a filler material used in the method are separate items. In contrast a consumable electrode welding technique is one where the electrode and filler are the same item and so the electrode is consumed in the process.

The internal face welding step is preferably conducted using a welding machine following the Gas Tungsten Arc Welding (GTAW) process. Plasma Arc Welding (PAW) may alternatively be used. One, two or more weld passes may be deposited from the internal side. Internal face welding can be performed orbitally (i.e. welding around the pipe circumference) or in either direction (i.e. vertically up or down.) Alternatively internal face welding can be performed with the tubular axis vertical so that the welding position is horizontal.

For the internal face, preferably the weld filler is a corrosion resistant alloy material such as the nickel Alloy 625. Depending on the pipe substrate material chemical composition alternative weld filler materials could be used including stainless steel (for example, Grade 316) and duplex stainless steels (for example 22% and 25% Cr grades) as well as alternative Ni based alloys or other weld filler materials. For the external face, a carbon steel weld filler may be used. This has the advantage of having the filler material in same material as the mother pipe providing mechanical and chemical properties close the mother pipe's properties and in addition is more cost effective as the price of CRA fillers such as super duplex and other stainless steels, are up to 3 to 6 time the price of carbon steel fillers.

In a preferred embodiment, the butt joint is welded:

(i) from the external side; then,
(ii) from the internal side; then,
(iii) from the external side again optionally to complete the weld.

It is preferred that during welding from the external side that the weld-filler used is not contacted with the corrosion resistant alloy cladding provided on the internal face.

The weld-filler used for the external side is preferably a carbon steel weld-filler typically selected to provide the necessary weld metal mechanical properties appropriate to the substrate pipe material. Suitable carbon steel wires include those defined by AWS specifications nos A5.18, A5.20. A5.28 and A5.29.

The welding step(s) for the external side may be conducted using an external welding machine employing various welding techniques such as Gas Tungsten Arc Welding (GTAW), Gas Metal Arc Welding (GMAW) or Flux-Cored Arc Welding (FCAW). If the tubular can be rotated during the welding process, then the Submerged Arc Welding (SAW) process can be used.

Close control of the bevel design and joint fit-up, together with selection of the optimum welding parameters, is needed to ensure that internal and external weld root passes are fully fused. Preferably, the bevel dimensions should be controlled to within 0.2 mm and the alignment of the first and second tubular should be controlled to within 0.5 mm. Precise control of the internal welding parameters is also needed to ensure that the root reinforcement is minimal and the transition to the adjacent parent material is smooth.

According to a further aspect of the present invention there is provided an apparatus comprising at least two tubulars having a corrosion resistant alloy provided on an internal face thereof, the tubulars being connected by a weldment, the weldment comprising a portion of filler on the external side of the tubulars and portion of filler on the inside of the tubulars.

Typically, the tubulars in accordance with the present invention are the tubulars described in the method according to the earlier aspects of the invention. Preferred and other optional features of the first aspect of the invention are to be considered preferred and optional features according to the second aspect of the invention.

In particular, the tubulars are preferably formed from a carbon steel tube having the corrosion resistant alloy provided on the internal face of the tube. Thus preferably the portion of filler on the internal side of the tubes comprises a corrosion resistant alloy, and the portion of filler on external side of the tubes comprises a carbon steel.

A preferred embodiment of the present invention will now be described by reference to the accompanying drawings in which:

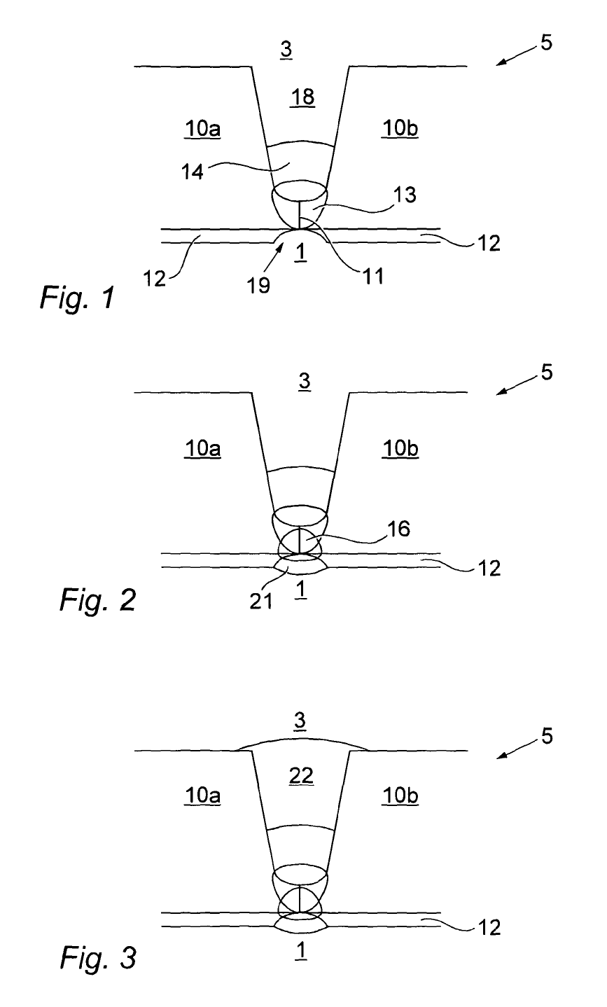

FIG. 1 is a cross sectional view of a butt-weld at a first stage in the method according to the present invention;

FIG. 2 is a cross sectional view of a butt-weld at a second stage in the method according to the present invention; and,

FIG. 3 is a cross sectional view of a completed butt-weld following a method according to the present invention.

FIG. 1 shows the ends of two steel tubulars 10a, 10b each comprising a corrosion resistant alloy (CRA) 12 formed on the inner side 1 thereof. Each end of the tubulars 10a, 10b have a J-shaped profile and are held together as shown in FIG. 1 to from a joint 5 in accordance with a method of the present invention and described in more detail below.

Tubulars 10a, 10b are butted together such that protruding portions partially defining the J-shape are in contact with each other ensuring that there is minimal misalignment (hi/low should preferably be less than 0.5 mm) and no gap between the abutting tubulars. The assembly process is facilitated by means of an internal clamp or alignment device (not shown). Before welding, there is a U-shaped void 18 defined between the tubulars 10a, 10b at an external side 3 thereof. A smaller U-shaped void 19 is defined between the risers 10a, 10b at an internal side 1 of the tubulars 10a, 10b. In particular the smaller void 19 is defined by the corrosion resistant alloy of the tubulars 10a, 10b, and the internal side 1.

Before the process is started, the clad tubular ends are initially machined to ensure uniform CRA thickness and a concentric internal radius at the weld joint location. The bevel on the tubular end may also be machined for the purposes of butt welding.

Welding of the external side 3 is performed initially using a carbon steel filler wire and an external welding machine (not shown). External welding is normally carried out using Gas Tungsten Arc Welding (GTAW), Gas Metal Arc Welding (GMAW) or Flux-Cored Arc Welding (FCAW). The use of an inert back purge gas may be used, if needed, on the internal side to avoid oxidation of an internal bevel and surfaces. FIG. 1 shows the first carbon steel filler 13, most of which has fused into the tubulars 10a, 10b at the root 11 of the connection there between, although a small portion remains above the root 11, taking up a small portion of the void 18.

A second external pass of welding carbon steel filler is performed at this stage in order to partly fill the external void 18 and this deposited filler is labelled 14 in FIG. 1. Notably at this point there is no contact with CRA material 12. In other embodiments, further external passes may be performed as required.

Subsequently, the joint 5 is welded from the internal face 1. For this pass, a corrosion resistant alloy is used as a filler material and an internal welding machine (not shown) used to deposit the filler. The internal welding machine may be obtained from Arc Machines, California USA or one of their stockists, such as WB Alloys in Glasgow, UK. The welding machine is coupled with a suitable drive mechanism for insertion into the inside of the tubulars 10a, 10b and cameras are attached to allow the welding process to be monitored and controlled remotely. The preferred welding process for the internal side 1 is GTAW.

The initial pass of CRA filler 16 is allowed to fuse into the root 11, with the carbon steel filler deposited in the first external pass which has also fused into this area, thus leaving only a small portion taking up some of the inner void 19. A second pass on the internal side with CRA filler 21 then fills the so-called void 19, as shown in FIG. 2. In other embodiments, further external passes may be performed as required.

The inventor of the present invention has recognised that deposition of CRA filler on carbon steel filler does not result in an increased risk of weld cracking whereas the reverse order, that is deposition of carbon steel onto CRA steel filler would increase such a risk. Thus the welding deposition sequence of carbon steel filler first, then CRA filler, is preferred since it minimises the possibility that the deposited carbon steel weld will be diluted with CRA material and result in weld cracking.

The weld is then completed from the external side using a carbon steel filler and the external welding machine. The deposited carbon steel filler material 22 fills the remaining space in the so-called void 18, as shown in FIG. 3. This may be achieved in one, two or more passes.

For certain other embodiments the third step shown in FIG. 3 is not required. The protruding filler material on the external side, referred to as the external weld reinforcement, may be ground smooth and/or flush depending on the application requirements. The direction of grinding and the surface finish are carried out in accordance with a controlled procedure.

The welding deposition sequence is also critical to ensure that a favourable residual stress distribution is achieved in the root region (ie, an absence of tensile residual stresses) which promotes good fatigue performance. This is accomplished by depositing the internal weld passes during the early stages of the butt welding method.

In alternative embodiments the tubular ends may comprise a single, instead of a double J design depending on the application requirements. Such a design could comprise for example, a void similar to the void 18 in the illustrated embodiment, but no void similar to the void 19 in the illustrated embodiment.

Embodiments of the invention benefit in that sufficiently strong circumferential butt welds may be performed for CRA high strength steel pipe whilst ensuring adequate weldment integrity.

Moreover for certain embodiments, manufacture of reelable steel caternary risers and flowlines with a CRA cladding or lining using the internal welding process in accordance with certain embodiments of the present invention confers one or more of the following benefits and advantages compared to the conventional method using only CRA material applied from the external side:
Exploitation and manufacture of reelable clad SCRs and flowlines in high strength steel pipe (with yield strengths in excess of Grade X60 pipe) is possible.
Substantial savings in filler wire costs by using a carbon steel filler
Improved weld metal mechanical properties by using a carbon steel filler wire.
Improved ultrasonic inspectability of the butt weld by eliminating most of the CRA weld material
The camera on the internal welding machine allows visual inspection of the as-deposited internal weld passes to be performed remotely providing greater assurance of the weld root integrity and an acceptable weld profile.
A double sided weld with a good internal weld profile is produced which is associated with better fatigue performance compared to single-sided welds.

Indeed for certain embodiments of the present invention the method allows high strength tubulars to be welded together without creating a weak point where the two joined tubulars can break. For certain embodiments this may be used for joining two high strength carbon steel tubulars of the strength rating X90-100 without any resulting loss of mechanical strength.

Moreover the finish, especially the internal shape, provided by certain methods in accordance with the present invention is good and requires no additional finishing, for example grinding. This is important when subsequently conducting pigging operations within the pipeline.

Another benefit of certain embodiments is that there is a continuity of the CRA material and therefore it is easier to take AUT (Automated Ultrasound Testing) measurements at the tubulars' interfaces.

Improvements and modifications may be made without departing from the scope of the invention.

1-15. (canceled)

16. A method of butt welding a first pipe segment and a second pipe segment together to form a section of pipeline, the pipe segments both being carbon steel tubes suitable for use in an underwater environment and comprising a corrosion resistant alloy on an internal face thereof, the method comprising:
butting the first pipe segment and the second pipe segment together and forming a butt joint by:
depositing from an external side of the first and second pipe segments a carbon steel weldfiller material onto the butt joint between the first and second pipe segments and performing a first welding operation from the external side; then
depositing from an internal side of the first and second pipe segments a corrosion resistant alloy weldfiller material onto the butt joint between the first and second pipe segments and performing a second welding operation from the internal side; and
depositing from the external side of the first and second pipe segments a carbon steel weldfiller material onto the butt joint between the first and second pipe segments and performing a third welding operation from the external side.

17. A method as claimed in claim 16, wherein the corrosion resistant alloy is mechanically bonded to the pipe segments to form a lining on the internal face thereof.

18. A method as claimed in claim 16, wherein the corrosion resistant alloy is chemically bonded to the pipe segments to form a cladding on the internal face thereof.

19. A method as claimed in claim 16, wherein the thickness of the corrosion resistant material is less than the thickness of the pipe segments without the corrosion resistant material.

20. The method as claimed in claim 16, wherein the deposition of the corrosion resistant alloy weldfiller on the internal face comprising the corrosion resistant alloy is performed using a non-consumable electrode welding technique.

21. The method as claimed in claim 16, wherein the outer diameter of the pipe segments is less than 24″ and the outer diameter of the pipe segments is more than 4″.

22. A method of deploying a section of pipeline in an underwater environment, the method comprising welding a plurality of pipe segments together to form the section of pipeline, each of the pipe segments being carbon steel tubes suitable for use in an underwater environment and comprising a corrosion resistant alloy on an internal face thereof, wherein each step of welding a first pipe segment to a second pipe segment of the plurality of pipe segments comprises butting the first pipe segment and the second pipe segment together; and forming a butt joint by:
depositing from an external side of the first and second pipe segments a carbon steel weldfiller material onto the butt joint between the first and second pipe segments and performing a first welding operation from the external side; then
depositing from an internal side of the first and second pipe segments a corrosion resistant alloy weldfiller material onto the butt joint between the first and second pipe segments and performing a second welding operation from the internal side; and
depositing from the external side of the first and second pipe segments a carbon steel weldfiller material onto the butt joint between the first and second pipe segments and performing a third welding operation from the external side;
the method further comprising deploying the section of pipeline comprising a plurality of pipe segments with butt joints therebetween in said underwater environment.

23. A section of pipeline comprising at least two pipe segments, the pipe segments each comprising a carbon steel tube with a corrosion resistant alloy lining on an internal face thereof and being connected by a weldment, the weldment comprising a first portion of carbon steel filler on an external side of an abutment between the pipe segments, a second portion of corrosion resistant alloy filler on an internal side of an abutment between the pipe segments and a third portion of carbon steel filler to the external side of the first portion of carbon steel filler wherein the first portion has been welded before the second portion and the second portion has been welded before the third portion.

24. A section of pipeline as claimed in claim 23, wherein the corrosion resistant alloy is mechanically bonded to the pipe segments to form a lining on the internal face thereof.

25. A section of pipeline as claimed in claim 23, wherein the corrosion resistant alloy is chemically bonded to the pipe segments to form a cladding on the internal face thereof.

26. A section of pipeline as claimed in claim 23, wherein the pipe segments' outer diameter is less than 24″ and wherein the pipe segments' outer diameter is more than 4″.

27. The method as claimed in claim 21, wherein the outer diameter of the pipe segments is less than 20″ and more than 8″.

28. The method as claimed in claim 27, wherein the outer diameter of the pipe segments is less than 16″.

29. A section of pipeline as claimed in claim 26, wherein the pipe segments' outer diameter is less than 20″ and wherein the pipe segments' outer diameter is more than 8″.

30. A section of pipeline as claimed in claim 29, wherein the pipe segments' outer diameter is less than 16″.
